(19) United States
(12) Patent Application Publication
(10) Pub. No.: US 2009/0275701 A1
(43) Pub. Date: Nov. 5, 2009

(54) Curable Composition Based On Polyurethane And On Block Copolymers, And Transparent Material Obtained From Said Composition

(75) Inventors: Boris Jaffrennou, Charenton Le Pont (FR); Noémie Lesartre, Charenton Le Pont (FR); Francoise Mechin, Charenton Le Pont (FR); Jean-Pierre Pascault, Charenton Le Pont (FR)

Correspondence Address: OCCHIUTI ROHLICEK & TSAO, LLP, 10 FAWCETT STREET, CAMBRIDGE, MA, 02138, US

(73) Assignee: Essilor International (compagnie Generale D'optiqu), Charenton Le Pont (FR)

(21) Appl. No.: 12/501,576

(22) Filed: Jul. 13, 2009

Related U.S. Application Data
(62) Division of application No. 11/623,463, filed on Jan. 16, 2007.

(30) Foreign Application Priority Data
Jan. 20, 2006 (FR) 0600552

(51) Int. Cl. C08L 53/00; G02C 7/02

(52) U.S. Cl. 525/88; 351/159

(57) ABSTRACT

Curable composition comprising: (a) one or more particular polyisocyanates or a polyurethane prepolymer obtained by the polycondensation of a polyisocyanate in excess, chosen from said polyisocyanates, with one or more polyols comprising at least two free alcohol functional groups, chosen from polypropoxylated or polyethoxylated bisphenol A compounds and polyfunctional polycaprolactone-alcohols; (b) one or more polyols comprising at least two free alcohol functional groups, chosen from polypropoxylated or polyethoxylated bisphenol A compounds and polyfunctional polycaprolactone-alcohols, and polyurethane prepolymers obtained by the polycondensation of one or more polyols in excess, chosen from the above polyols, with one or more particular polyisocyanates, the ratio of the number of isocyanate functional groups of the polyisocyanate component (a) to the number of alcohol functional groups of the polyol component (b) being between 1.00 and 1.20; and (c) 5% to 80% by weight, relative to the total weight of (a), (b) and (c), of one or more polystyrene-block-polybutadiene-block-poly(methyl methacrylate) block copolymers;

method of preparing such a composition and transparent optical material obtained by heating said composition.

This application claims priority to French Application Serial No. 06 00552, filed on Jan. 20, 2006, and U.S. application Ser. No. 11/623,463, filed on Jan. 16, 2007. The contents of both applications are hereby incorporated by reference in their entirety.

The present invention relates to novel curable compositions based on particular polyols, polyisocyanates and block copolymers, to transparent finished materials obtained by reaction of these compositions, and to a method of preparing curable compositions and transparent finished materials. These materials are particularly useful for production of optical articles and more particularly ophthalmic articles.

There are two types of substrate generally used for the manufacture of optical articles, especially ophthalmic lenses, namely substrates made of a mineral glass and substrates made of an organic glass. At the present time, the market is developing very substantially in favour of organic glasses, which have the advantage of being lighter than mineral glasses and of being more impact-resistant. The organic glass substrates most used are a plastic polycarbonate and the polycarbonate obtained by polymerization of diethylene glycol bis(allyl carbonate).

In its research aimed at continually developing new high-performance materials for the manufacture of optical materials, the Applicant has found that polyurethane-type materials are useful candidates for the manufacture of transparent materials that can be used for example to manufacture optical products, such as ophthalmic lenses or polymeric films of optical quality.

Such materials are known to those skilled in the art. However, the handling of precursors of the polyol and polyisocyanate type in liquid form, in which state these compounds exist, is subjected to constraints. These constraints are exacerbated by the fact that isocyanates are toxic compounds requiring specific means of containment for handling and storing them in liquid form. Finally, these products in the liquid state generally have a high reactivity, limiting their capability of being stored satisfactorily.

The reaction between an isocyanate functional group and an alcohol functional group can be very rapid and the processing of polyurethanes may consequently require the use of quite complex processes such as RIM (reaction injection moulding) or RTM (reaction transfer moulding). It would be useful to be able to process polyurethanes by simpler processes, such as extrusion, injection moulding or coextrusion, and to be able to have available solid compositions for obtaining such polyurethanes, which compositions would be much easier to store, contain and form.

More particularly, the Applicant has therefore developed novel curable compositions based on particular polyols, polyisocyanates and block copolymers. These compositions, after a thermal curing step, give a transparent material of the polyurethane type and have the required physical properties for being used in particular for the manufacture of ophthalmic articles.

The incorporation of such block copolymers into epoxidized matrices has been described for example in Patent Application WO 01/92415. Epoxy materials modified by the incorporation of block copolymers retain their transparency, have their mechanical properties improved and experience only a small drop in the T_{g} (glass transition temperature).

Consequently, one subject of the present invention is a curable composition comprising:

(a)—one or more polyiosocyanates comprising at least two free isocyanate functional groups, chosen from:
(1) xylylene diisocyanate (XDI), meta-tetramethylxylylene diisocyanate (TMXDI), cycloaliphatic diisocyanates, the trimer of isophorone diisocyanate and the trimer of hexamethylene diisocyanate; and
(2) polyurethane prepolymers obtained by the polycondensation of one or more polyisocyanates in excess, chosen from the above polyisocyanates (1), with one or more polyols comprising at least two free alcohol functional groups, chosen from the family of polypropoxylated biphenol A compounds containing on average 1 to 10 propylene oxide units on either side of the central bisphenol A group, the family of polyethoxylated bisphenol A compounds containing on average 1 to 15 ethylene oxide units on either side of the central bisphenol A group, and the family of difunctional, trifunctional and tetrafunctional polycaprolactone-alcohols;
   (b)—one or more polyols comprising at least two free alcohol functional groups, chosen from:
(1) the family of polypropoxylated bisphenol A compounds containing on average 1 to 10 propylene oxide units on either side of the central bisphenol A group, the family of polyethoxylated bisphenol A compounds containing on average 1 to 15 ethylene oxide units on either side of the central bisphenol A group and the family of difunctional, trifunctional and tetrafunctional polycaprolactone-alcohols;
(2) polyurethane prepolymers obtained by the polycondensation of one or more polyols in excess, chosen from the above polyols (1), with one or more polyisocyanates chosen from xylylene diisocyanate (XDI), meta-tetramethylxylylene diisocyanate (TMXDI), cycloaliphatic diisocyanates, the trimer of isophorone diisocyanate and the trimer of hexamethylene diisocyanate;
the ratio of the number of isocyanate functional groups of the polyisocyanate component (a) to the number of alcohol functional groups of the polyol component (b) being between 1.00 and 1.20; and
   (c) 5% to 80% by weight, relative to the total weight of (a), (b) and (c), of one or more polystyrene-block-polybutadiene-block-poly(methyl methacrylate) block copolymers (SBM).

The polystyrene-block-polybutadiene-block-poly(methyl methacrylate) block copolymers may be introduced during preparation of the curable composition either by blending them with the polyisocyanate component (a), or by blending them with the polyol component (b) of the curable composition, or by blending them both with the polyisocyanate component (a) and with the polyol component (b) of the composition.

In the latter case, the invention comprises the possibility of using polystyrene-block-polybutadiene-block-poly(methyl methacrylate) block copolymers (SBM) of different molecular weight and different composition in the polyisocyanate component (a) of the composition and in the polyol component (b) of said curable composition. The proportion by weight of block copolymers in the polyisocyanate part (a) and in the polyol part (b) may be different.

Preferably, the block copolymers blended, during preparation of the curable composition, with the polyisocyanate component (a) are the same as those blended with the polyol component (b).

In one particularly advantageous embodiment of the invention, the polyisocyanate(s) used in the polyisocyanate component (a) are the same as those used in the polyol component (b), the polyol(s) used in the polyisocyanate component (a) are the same as those used in the polyol component (b), and the block copolymer (c) mixed, during preparation of the curable composition, with the polyisocyanate component (a) is the same as that blended with the polyol component (b).

Such a composition, after thermally induced reaction, gives rise to a polyurethane (PU) material of suitable transparency for it to be used as optical material, for example for the manufacture of ophthalmic lenses or for supports, such as films compatible with ophthalmic use.

Another subject of the present invention is a transparent material obtained by thermally induced reaction of the above curable composition and another subject is an optical article, preferably an ophthalmic lens, comprising such a material.

In the present application, the definitions of certain terms must be understood as follows:
“optical article” is understood to mean optical lenses for instruments and for sight, visors and ophthalmic lenses, and also films of optical quality that can be used within an optical lens, visor or ophthalmic lens; and
“ophthalmic lens” is understood to mean lenses that may especially be fitted into a spectacle frame, with the function of protecting the eyes and/or correcting sight, these lenses being chosen from afocal, unifocal, bifocal, trifocal and progressive lenses.

Other subjects of the present invention are a method of preparing the curable composition and a method of preparing the polyurethane material, these methods being described in greater detail below.

In a preferred embodiment of the invention, the isocyanate used is a cycloaliphatic diisocyanate. The preferred diisocyanate for preparing the polyurethanes of the present invention is isophorone diisocyanate (IPDI).

In the present invention, to prepare the curable composition it will be preferred to use a polypropoxylated bisphenol A containing on average 1 to 10 propylene oxide (PO) units on either side of the bisphenol A group, and preferably 3.5 to 8 propylene oxide units on either side of the central bisphenol A group, by itself or as a blend, and particularly a polypropoxylated bisphenol A containing on average 3.5, 5.5 or 7.5 propylene oxide units on either side of the central bisphenol A group, hereafter called 3.5PO-BPA, 5.5 PO-BPA and 7.5 PO-BPA, respectively.

It is also important in the curable composition of the present invention to use a molar ratio of the number of isocyanate functional groups to the number of alcohol functional groups close to 1, or even slightly greater than this value, since having these two types of functional groups in almost stoichiometric proportion ensures a degree of polymerization sufficient to obtain a material with a high glass transition temperature (Tg), which can be used in particular for the manufacture of ophthalmic lenses. Thus, according to a preferred embodiment of the invention, the curable composition has a ratio of the number of isocyanate functional groups of the polyisocyanate component (a) to the number of alcohol functional groups of the polyol component (b) between 1.00 and 1.05.

The curable composition of the present invention preferably contains 30 to 80% by weight, more preferably 40 to 60% by weight and in particular about 50% by weight, of polystyrene-block-polybutadiene-block-poly(methyl methacrylate) block copolymers (SBM) relative to the total weight of (a), (b) and (c). This amount makes it possible inter alia to improve the physical properties, and especially the mechanical properties, of material obtained from this curable composition.

The block copolymers that can be used within the context of the invention are for example described in Patent Applications WO 2005/073314 and WO 2005/014699. The reader may particularly refer to these documents for a detailed description of the polystyrene S, polybutadiene B and polymethyl methacrylate M parts of said SBM block copolymers.

Finally, it is important for obtaining transparent polyurethane materials for the poly(methyl methacrylate) (PMMA) block of the block copolymer to represent a large fraction of the molecular weight of the block copolymer. According to an advantageous embodiment of the invention, the PMMA block preferably represents from 50% to 80% by weight, more preferably 55% to 75% by weight and in particular 60 to 70% by weight of the weight-average molecular weight of the polystyrene-block-polybutadiene-block-poly(methyl methacrylate) block copolymer. For similar reasons, the weight-average molecular weight of said polymethyl methacrylate block is preferably between 10 000 and 100 000 g/mol for an overall weight-average molecular weight of the block copolymer of preferably between 15 000 and 200 000 g/mol.

Within the context of the invention, it should be understood that the block copolymers used may be a blend of a tribloc copolymer and a dibloc copolymer of the polystyrene-block-polybutadiene type. These copolymers are for example described in Patent Application WO 2005/073314.

The polyurethane materials obtained from the curable compositions described above have sufficient transparency for them to be used in the optics field and in particular in the ophthalmic field. This transparency is due to the structuring of the material by the block copolymers, resulting in the formation of nanodomains containing at least the B block of said SBM.

To improve certain properties of the optical products manufactured from the curable materials of the present invention, for example the impact strength, the abrasion and scratch resistance, the antireflection character and the resistance to soiling, it is possible to form one or more functional coatings on at least one of the principal surfaces. Thus, it is very possible to form, in succession, on one principal face of the optical article of polyurethane according to the invention, a first coating, called an impact-resistant primer, the function of which is to increase the impact strength of the article but also the adhesion of subsequent coatings to the substrate, then, on this impact-resistant primer coating, a hard coating, generally called an abrasion-resistant or scratch-resistant coating, the purpose of which is to improve the capability of the surface of the optical article to be resistant to damage due to mechanical abuse. It is also possible to superimpose, on the abrasion-resistant coating, an antireflection coating on which may optionally be superimposed an anti-soiling coating, the purpose of which is to modify the interfacial tension between the antireflection layer and water or grease, but also to close off interstices so as to prevent grease from infiltrating and remaining therein. The optical article may be also include an antistatic coating.

As indicated above, another subject of the present invention is a method of preparing a curable composition as described above, comprising the following steps:
i. preparation of a first composition (A) by blending the polyisocyanate component (a) with a polystyrene-block-polybutadiene-block-poly(methyl methacrylate) block copolymer (c), the weight ratio of the polyisocyanate component (a) to the block copolymer (c) being between 95/5 and 20/80;
ii. preparation of a second composition (B) by blending the polyol component (b) with a polystyrene-block-polybutadiene-block-poly(methyl methacrylate) block copolymer (c), the weight ratio of the polyol component (b) to the block copolymer (c) being between 95/5 and 20/80; and
iii. blending of the first composition (A) with the second composition (B) in respective amounts such that the ratio of the number of isocyanate functional groups to the number of alcohol functional groups is between 1.00 and 1.20.

According to a first variant, the invention also comprises a method of preparing a curable composition comprising the following steps:
i. preparation of a composition (A) by blending the polyisocyanate component (a) with a polystyrene-block-polybutadiene-block-poly(methyl methacrylate) block copolymer (c), the weight ratio of the polyisocyanate component (a) to the block copolymer (c) being between 95/5 and 20/80; and
ii. blending of the polyol component (b) with the composition (A) in respective amounts such that the ratio of the number of isocyanate functional groups to the number of alcohol functional groups is between 1.00 and 1.20.

According to a second variant, the invention also comprises a method of preparing a curable composition comprising the following steps:
i. preparation of a composition (B) by blending the polyol component (b) with a polystyrene-block-polybutadiene-block-poly(methyl methacrylate) block copolymer (c), the weight ratio of the polyol component (b) to the block copolymer (c) being between 95/5 and 20/80; and
ii. blending of the composition (B) with the polyisocyanate component (a) in respective amounts such that the ratio of the number of isocyanate functional groups to the number of alcohol functional groups is between 1.00 and 1.20.

The preparation of such a curable composition is particularly facilitated by its processing options. Thus, the preparation of the first composition (A) and the preparation of the second composition (B) by blending their respective components are carried out separately and independently, preferably by extrusion in an extruder, preferably a twin-screw extruder, at maximum temperatures ranging between 100° C. and 150° C. This extrusion is preferably followed by granulation of the extruded rods on exiting the die. The granules may be easily stored. Thanks to the method processing the curable composition according to the invention, it is therefore possible to obtain, and to store under ambient temperature conditions, the two precursor components of the finished polyurethane material independently and in a chemically stable manner.

The granules thus obtained may then be introduced in the appropriate proportions into an extruder, preferably a twin-screw extruder, at a maximum temperature between 120 and 140° C., preferably at a temperature between 125 and 135° C.

The extruded curable composition thus obtained therefore results in an intermediate curable composition in the form of a reactive compound. By storing this reactive compound at a temperature below room temperature the physico-chemical and mechanical properties thereof are stable. This intermediate curable composition may thus be stored in the form of granules or as film, depending on the geometry of the die used at the extruder exit.

In another variant, the two precursor components of the finished polyurethane material that are obtained in the form of independent granules as described above may be coextruded. In such a configuration of the method, what is obtained is an intermediate curable composition in the form of granules or film in which there is no intimate mixing between the reactive functional groups of the first component (Composition A) and the reactive functional groups of the second component (Composition B), but only an interface or interphase between these two components. Such a curable composition is stable and can be easily stored at room temperature. It may also be used as such, especially if it is in the form of a film.

The extruded or coextruded curable composition thus obtained can then be processed, for example by moulding, injection moulding or thermoforming, and exposed to a temperature between 100° C. and 170° C. for a time of between 1 hour and 15 hours so as to give a transparent cured material according to the present invention.

According to a preferred variant of the invention, the first composition (A) in the form of granules and the second composition (B) in the form of granules are blended with the alcohol and isocyanate functional groups in stoichiometric (or almost stoichiometric) proportions, poured into the hopper of an injection moulding machine and then injected into a mould. The thermal curing within the mould of the injection moulding machine results in a product comprising a transparent polyurethane material. The mould of the injection moulding machine is advantageously an ophthalmic lens insert, thus making it possible to obtain ophthalmic lenses.

The invention will now be illustrated with the aid of an example according to the invention.

### EXAMPLE

The synthesized polyurethane matrix was of IPDI/3.5PO-BPA type.

TABLE I
Characteristics of the IPDI

| | | M | Eq_{NCO} | | δ | |
|---|---|---|---|---|---|---|
| Diisocyanate | Chemical formula | (g/mol) | (mol/kg) | n^{D}₂₀ | (MPa)^{1/2} | Supplier |
| IPDI (Isophorone diisocyanate) | 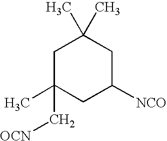 | 222.2 | 8.978 | 1.483 | 21.6 | Crenova |

TABLE 2
Characteristics of the 3.5PO-BPA (Supplier: SEPPIC S.A.)

| | | | T_{g midpoint} | | |
|---|---|---|---|---|---|
| | | | (° C.) | | |
| | | Mₙ | ΔCₚ (J · | | δ |
| Product | x + y | (g/mol) | K⁻¹ · mol⁻¹) | n^{D}₂₀ | (MPa)^{1/2} |
| Simulsol | 6.8 | 625 | −44 (±2) | 1.503 | 20.2 |
| BPMP ® | | | | | |
| 3.5PO-BPA | | | 0.55 (±0.04) | | |

The block copolymer used in this example was a PS-b-PB-b-PMMA of 41 900 gram-average molecular weight in which the mass fraction of the PMMA segment was greater than 50%.

The polyurethane material nanostructured by 50% SBM was synthesized according to the following protocol:

Two rods, 3.5PO-BPA/SBM and IPDI/SBM (50/50 by weight), were extruded and then granulated. The granules were prepared in a recirculation twin-screw micro extruder of the of the DSM micro 15 type. For each type of granule, the preparation of the blend was carried out in the following manner: the monomer, in liquid form, was firstly introduced into the extruder (at room temperature in the case of the 1'IPDI, at 80° C. in the case of the alcohol) before the SBM powder was progressively added. The blend was left recirculating for 30 min until a homogenous rod was obtained, at a screw speed of 10 rpm. The 3.5PO-BPA/SBM rod was processed at 140° C. and the IPDI/SBM rod was processed at 80° C. The quantities incorporated were:

Rod 1 (IPDI/SBM):

m_{IPDI}=9.212 g

m_{SBM}=9.138 g.

Rod 2 (3.5PO-BPA/SBM):

m_{3.5PO-BPA}=9.418 g

m_{SBM}=9.390 g.

Comparison between the theoretical and experimental values obtained by chemical assay of the isocyanate functional group confirmed that the isocyanate functional groups were not degraded during the reaction of forming the IPDI/SBM rod.

We thus obtained two batches of macroscopically homogenous granules of IPDI/SBM and 3.5PO-BPA/SBM.

The 3.5PO-BPA/SBM and IPDI/SBM granules were then blended in solid form in an NCO/OH ratio=1 according to the isocyanate equivalent determined by chemical assay of the isocyanate/SBM granules and the hydroxyl number of the 3.5PO-BPA alcohol determined beforehand according to the experimental protocol as supplied in the NF T52-112 standard.

The masses of the blended granules were the following:

m_{IPDI/SBM granules}=4.351 g

m_{3.5PO-BPA/SBM}=12.238 g.

The blend of the two rods was incorporated into the recirculation twin-screw micro extruder of the DSM micro 15 type and left recirculating for 30 min until a homogeneous rod was obtained, at a screw speed of 10 rpm. The rod was recovered and placed in a dural mould covered with a PTFE-coated paper and containing a 4 mm thick spacer preheated to 150° C., then the blend was cured under pressure (10 bar) directly so as to avoid subjecting the specimens to a thermal quench. The blend was then cured by heating for 4 hours at 150° C. followed by 1 h at 170° C.

1.-24. (canceled)

25. A method of preparing a polyurethane composition, comprising the following steps:
i. preparation of a first composition (A) by blending
(a) one or more polyisocyanates comprising at least two free isocyanate functional groups, chosen from:
(1) xylylene diisocyanate (XDI), meta-tetramethylxylylene diisocyanate (TMXDI), cycloaliphatic diisocyanates, the trimer of isophorone diisocyanate and the trimer of hexamethylene diisocyanate; and
(2) polyurethane prepolymers obtained by the polycondensation of one or more polyisocyanates in excess, chosen from the above polyisocyanates (1), with one or more polyols comprising at least two free alcohol functional groups, chosen from the family of polypropoxylated biphenol A compounds containing on average 1 to 10 propylene oxide units on either side of the central bisphenol A group, the family of polyethoxylated bisphenol A compounds containing on average 1 to 15 ethylene oxide units on either side of the central bisphenol A group, and the family of difunctional, trifunctional and tetrafunctional polycaprolactone-alcohols; with
(c) a polystyrene-block-polybutadiene-block-poly(methyl methacrylate) block copolymer, the weight ratio of the polyisocyanate component (a) to the block copolymer (c) being between 95/5 and 20/80;
ii. preparation of a second composition (B) by blending
(b) one or more polyols comprising at least two free alcohol functional groups, chosen from:
(1) polypropoxylated bisphenol A compounds containing on average 1 to 10 propylene oxide units on either side of the central bisphenol A group, the family of polyethoxylated bisphenol A compounds containing on average 1 to 15 ethylene oxide units on either side of the central bisphenol A group and the family of difunctional, trifunctional and tetrafunctional polycaprolactone-alcohols;
(2) polyurethane prepolymers obtained by the polycondensation of one or more polyols in excess, chosen from the above polyols (1), with one or more polyisocyanates chosen from xylylene diisocyanate (XDI), meta-tetramethylxylylene diisocyanate (TMXDI), cycloaliphatic diisocyanates, the trimer of isophorone diisocyanate and the trimer of hexamethylene diisocyanate;
the ratio of the number of isocyanate functional groups of the polyisocyanate component (a) to the number of alcohol functional groups of the polyol component (b) being between 1.00 and 1.20; with
(c) a polystyrene-block-polybutadiene-block-poly(methyl methacrylate) block copolymer, the weight ratio of the polyol component (b) to the block copolymer (c) being between 95/5 and 20/80; and
iii. blending of the first composition (A) with the second composition (B) in respective amounts such that the ratio of the number of isocyanate functional groups to the number of alcohol functional groups is between 1.00 and 1.20.

26. The method according to claim 25, wherein the polystyrene-block-polybutadiene-block-poly(methyl methacrylate) block copolymer (c) is used in an amount of 5% to 80% by weight, relative to the total weight of (a), (b) and (c).

27. The method according to claim 26, wherein the polystyrene-block-polybutadiene-block-poly(methyl methacrylate) block copolymer (c) is used in an amount of 30% to 80% by weight, relative to the total weight of (a), (b) and (c).

28. The method according to claim 27, wherein the polystyrene-block-polybutadiene-block-poly(methyl methacrylate) block copolymer (c) is used in an amount of 40% to 60% by weight, relative to the total weight of (a), (b) and (c).

29. The method according to claim 25, wherein the block copolymer (c) blended, during preparation of the curable composition, with the polyisocyanate component (a) is the same as the block copolymer (c) blended with the polyol component (b).

30. The method according to claim 25, wherein the polyisocyanate(s) used in the polyisocyanate component (a) are the same as those used in the polyol component (b), the polyol(s) used in the polyisocyanate component (a) are the same as those used in the polyol component (b), and the block copolymer(s) (c) mixed, during preparation of the curable composition, with the polyisocyanate component (a) are the same as that or those blended with the polyol component (b).

31. The method according to claim 25, wherein the polyisocyanate is chosen from cycloaliphatic diisocyanates.

32. The method according to claim 31, wherein the polyisocyanate is isophorone diisocyanate (IPDI).

33. The method according to claim 25, wherein the polyol is selected from polypropoxylated bisphenol A compounds containing on average 1 to 10 propylene oxide (PO) units on either side of the bisphenol A group.

34. The method according to claim 33, wherein the polyol is selected from polypropoxylated bisphenol A compounds containing on average 3.5 to 8 propylene oxide units on either side of the central bisphenol A group.

35. The method according to claim 34, wherein the polyol is selected from polypropyoxylated bisphenol A compounds containing on average 3.5, 5.5 and 7.5 propylene oxide units on either side of the central bisphenol A group.

37. The method according to claim 25, wherein the ratio of the number of isocyanate functional groups of the polyisocyanate component (a) to the number of alcohol functional groups of the polyol component (b) is between 1.00 and 1.05.

38. The method according to claim 25, wherein the polymethyl methacrylate (PMMA) block of the block copolymer represents 50% to 80% by weight of the weight-average molecular weight of the polystyrene-block-polybutadiene-block-poly(methyl methacrylate) block copolymer.

39. The method according to claim 37, wherein the polymethyl methacrylate (PMMA) block of the block copolymer represents 60% to 70% by weight of the weight-average molecular weight of the polystyrene-block-polybutadiene-block-poly(methyl methacrylate) block copolymer.

40. The method according to claim 25, wherein the blending of the polyisocyanate component (a) with the block copolymer (c) and the blending of the polyol component (b) with the block copolymer (c) is carried out by extrusion in an extruder.

41. The method according to claim 39, wherein the blending of the polyisocyanate component (a) with the block copolymer (c) and the blending of the polyol component (b) with the block copolymer (c) is carried out at maximum temperatures ranging from 100° C. to 150° C.

42. The method according to claim 25, further comprising storing the resulting composition at a temperature below room temperature.

43. The method according to claim 25, further comprising, after blending the first composition with the second composition, processing of the resulting composition by moulding, injection moulding or thermoforming and exposing it to temperatures ranging from 100° C. to 170° C. for a time between 1 hour and 15 hours so as to obtain a transparent cured material.
